(19) United States
(12) Patent Application Publication
(10) Pub. No.: US 2019/0305714 A1
(43) Pub. Date: Oct. 3, 2019

(54) Wearable Energy Collection Device

(71) Applicant: Paul Garcia, Van Nuys, CA (US)

(72) Inventor: Paul Garcia, Van Nuys, CA (US)

(21) Appl. No.: 16/177,545

(22) Filed: Nov. 1, 2018

Related U.S. Application Data
(60) Provisional application No. 62/649,177, filed on Mar. 28, 2018.

(51) Int. Cl. H02S 10/40; H02N 2/18

(52) U.S. Cl. CPC H02S 10/40; H02K 7/1853; H02N 2/18

(57) ABSTRACT

A wearable energy collection device. The wearable energy collection device includes a housing having a plurality of straps, configured to attach the housing to an arm of an individual. The housing includes a plurality of energy collection systems, including at least one solar energy harvesting system, at least one kinetic energy harvesting system, and at least one electrostatic energy harvesting system. The plurality of energy collection systems are operably connected to an energy storage device within the housing, which stores energy collected by one or more energy collection systems of the plurality of energy collection systems. The energy storage device is configured to power a light and a clock positioned on an exterior of the housing, or to power or charge an external device. The wearable energy collection device is useful for converting energy from an environment into usable stored energy.

### CROSS REFERENCE TO RELATED APPLICATIONS

This application claims priority under 35 U.S.C. § 119(e) to U.S. Provisional Application No. 62/649,177 filed on Mar. 28, 2018. The above identified patent application is incorporated by reference herein in its entirety to provide continuity of disclosure.

### BACKGROUND OF THE INVENTION

The present invention relates to a wearable energy collection device for collecting energy from a plurality of sources of an environment for any of a plurality of uses.

Access to electricity to power electronic devices is often limited due to a lack of electricity access points. This may occur when traveling, spending time outdoors, or navigating an emergency. Limited access to electricity is not only an inconvenience, but may exacerbate the emergency if limited or no access occurs for an extended period. If an individual is traveling in remote areas, or navigating an emergency without electricity for an extended period of time, existing solutions are insufficient. For example, backup batteries will run out of energy, leaving the individual unable to utilize electronic devices necessary for navigating the emergency, such as vision or imaging equipment (e.g., night vision goggles or cameras), navigational equipment (e.g., global positioning system devices), or communications equipment (e.g., radio). Existing solutions for off-the-grid energy generation, storage, and use are generally bulky and difficult to transport.

Therefore, there is a need in the art for a device for collecting energy from an environment that is independent of ordinary electricity access points, which finds utility in remote or rugged environments, or settled or urban environments during an emergency. The present invention addresses this unmet need.

Devices have been disclosed in the art that relate to off-the-grid energy collection. These include devices that have been patented and published in patent application publications. These devices are often unsatisfactory, because they are large, bulky, and difficult to transport. In view of the devices disclosed in the art, it is submitted that there is a need in the art for an improvement to existing energy collection devices. In view of the present disclosure, it is submitted that the present invention substantially diverges in structural and functional elements from devices in the art, and substantially fulfills an unmet need in the art.

### SUMMARY OF THE INVENTION

In view of the disadvantages inherent in the known types of energy collection devices in the art, the present invention provides a new and improved wearable energy collection device, wherein the same can be utilized for collecting energy from a plurality of sources of an environment.

It is therefore an object of the present invention to provide a wearable energy collection device for collecting, storing, and discharging electricity.

In one aspect, the invention provides a wearable energy collection device, comprising a housing having a plurality of straps thereon, configured to attach the housing to an arm of an individual. The housing includes a plurality of energy collection systems in an interior of the housing, wherein the plurality of energy collection systems includes at least one solar energy harvesting system, at least one kinetic energy harvesting system, and at least one electrostatic energy harvesting system. The wearable energy collection device includes an energy storage device in the interior of the housing, operably connected to the plurality of energy collection systems, and configured to store energy collected by one or more energy collection systems of the plurality of energy collection systems.

Another object of the present invention is to provide a wearable energy collection device that may be readily manufactured from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of the invention will be particularly pointed out in the claims, the invention itself and manners in which it may be made and used may be better understood after a review of the following description, taken in connection with the accompanying drawings, wherein like numeral annotations are provided throughout.

FIG. 1 depicts a top view of an exemplary wearable energy collection device.

FIG. 2 depicts a front left perspective view of the exemplary wearable energy collection device secured to an arm of an individual.

FIG. 3 depicts a front left perspective view of the exemplary wearable energy collection device.

FIG. 4 depicts a diagram of a set of components of the exemplary wearable energy collection device.

### DETAILED DESCRIPTION OF THE INVENTION

Reference is made herein to the attached drawings. Like reference numerals are used throughout the drawings to depict like or similar elements of the invention. The figures are intended for representative purposes only and should not be considered limiting in any respect.

Reference is now made to the drawings, which depict one or more exemplary embodiments of the invention.

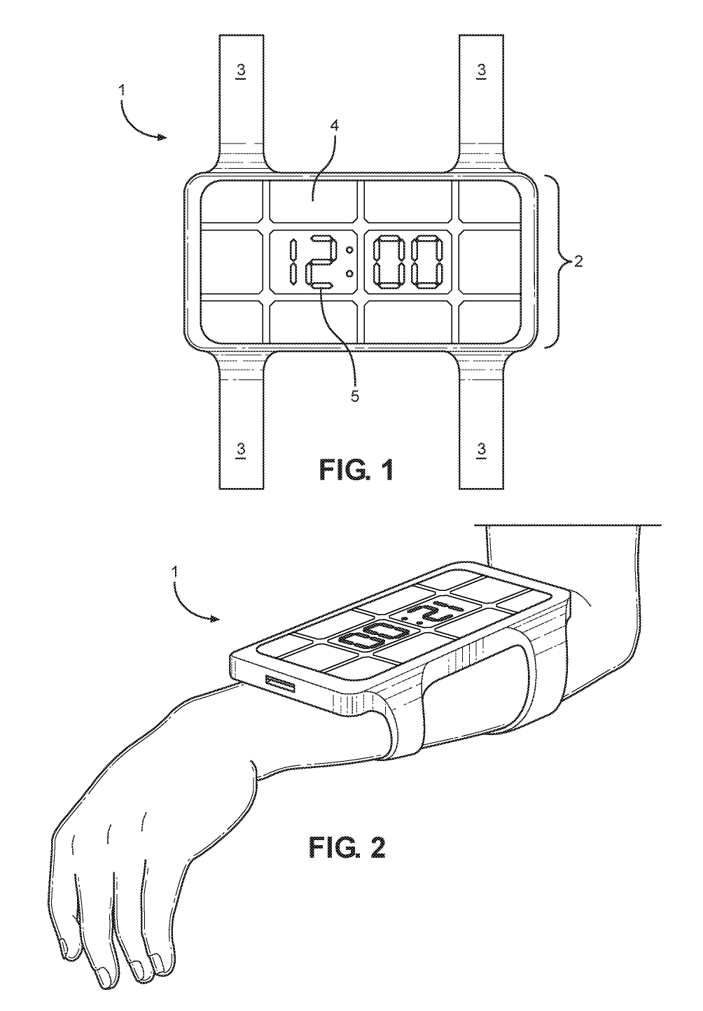

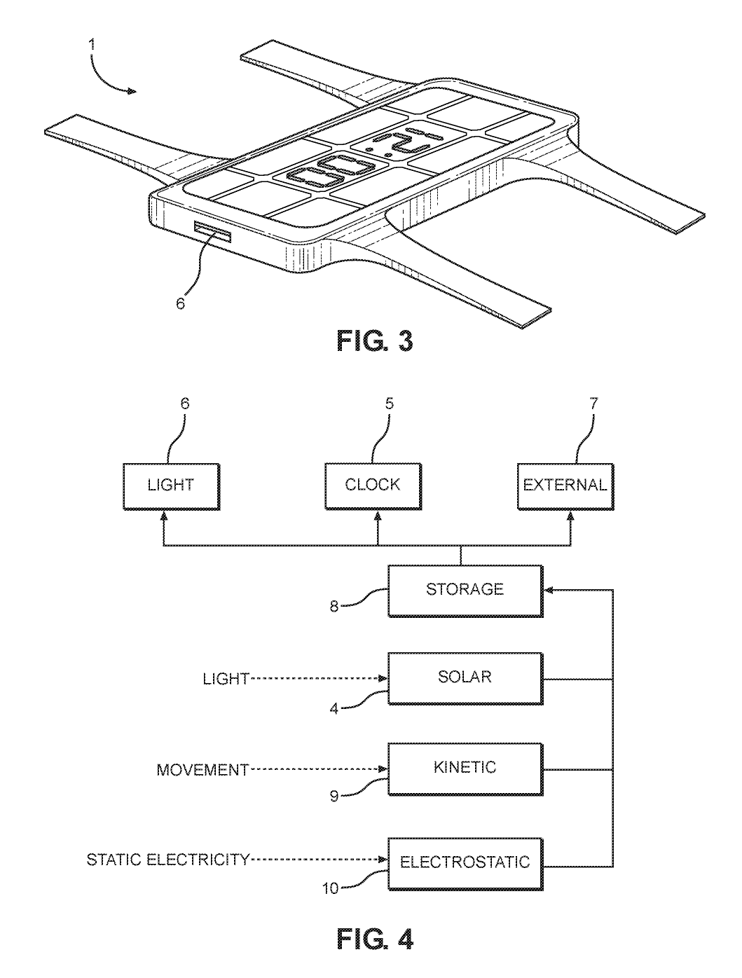

Referring now to FIGS. 1-4, there are depicted several views of an exemplary wearable energy collection device. A wearable energy collection device 1 includes a housing 2 having a plurality of straps 3, configured to attach the housing 2 to an arm of an individual. A plurality of energy collection systems are positioned in an interior of the housing 2, wherein the plurality of energy collection systems includes at least one solar energy harvesting system 4, at least one kinetic energy harvesting system 9, and at least one electrostatic energy harvesting system 10. An energy storage device 8 disposed in the interior of the housing 2 is operably connected to the plurality of energy collection systems and configured to store energy collected by one or more energy collection systems of the plurality of energy collection systems.

In some embodiments, the wearable energy collection device 1 includes a light 6 operably connected to the energy storage device 8. In this manner, the energy storage device 8 is configured to power the light 6 for illuminating the surrounding area. In some embodiments, the wearable energy collection device 1 includes a clock 5 operably connected to the energy storage device 8. In this manner, the energy storage device 8 is configured to power the clock 5. In some embodiments, the clock 5 is configured to display a time on an outer surface of the housing 2. In this manner, the individual wearing the wearable energy collection device 1 can observe the time displayed on the outer surface of the housing 2.

In some embodiments, the wearable energy collection device 1 includes an external port 7 configured to enable the energy storage device 8 to power or charge an external device operably connected to the external port 7. In some embodiments, the external port 7 includes a universal serial bus (USB) interface. In this manner, the wearable energy collection device 1 is compatible with a plurality of external devices.

In some embodiments, the energy storage device 8 is a rechargeable battery, such as a lithium ion rechargeable battery. In this manner, the energy storage device 8 may be manufactured, assembled, or obtained by reliable means to facilitate construction of the wearable energy collection device 1.

In some embodiments, the at least one solar energy harvesting system 4 includes at least one solar panel placed on an outer surface of the housing 2. In some embodiments, the housing 2 is a rectangular cuboid with rounded edges, wherein the outer surface is an upper surface positioned above a lower surface of the housing, wherein the lower surface is configured to contact the arm of the individual. In this manner, the at least one solar energy harvesting system 4 is able to efficiently harvest solar energy from the environment.

In the shown embodiment, a forward portion and a rearward portion of the housing 2 extends beyond the plurality of straps 3, such that an area of the upper surface is maximized while still enabling the housing 2 to be sized and configured for placement on a forearm of the individual. In this manner, the at least one solar panel is maximally sized while retaining the ability of the individual to wear the wearable energy collection device 1. The maximally sized upper surface is thus configured to maximize solar energy harvested by the at least one solar panel thereon.

In the shown embodiment, the housing 2 includes a forward pair of straps 3 and a rearward pair of straps 3. In this manner, the wearable energy collection device 1 is sized and configured to be secured to the forearm of the individual. However, in alternate embodiments, the housing 2 includes one strap 3, two straps 3, three straps 3, four straps 3, or any number of straps 3 so that the wearable energy collection device 1 is sized and configured to be secured to another object or surface, including but not limited to a hat, an article of clothing, a helmet, a bag, a backpack, a vehicle, an all-terrain vehicle, a human-powered vehicle, or any other device or article that may be employed as part of an operation in a remote or rugged environment, or as part of an emergency or conflict, including an armed conflict. In alternate embodiments, alternative means for securing the housing to any object or surface are envisioned, including hook-and-loop fasteners, buttons, magnets, adhesive, or any other permanent, semi-permanent, or non-permanent attachment means, as would be understood by a person having ordinary skill in the art.

It is envisioned that the present invention include any and all variations in size or configuration, with the intention being that the wearable energy collection device be relatively easy to store, transport, use, and maintain. In this manner, the exact size, shape, or configuration of the wearable energy collection device may be adjusted or optimized to suit a particular application, without deviating from the spirit and scope of the present invention.

The foregoing descriptions of specific embodiments of the present invention have been presented for purposes of illustration and description. They are not intended to be exhaustive or to limit the present invention to the precise forms disclosed, and modifications and variations are possible in view of the above teaching. The exemplary embodiment was chosen and described to best explain the principles of the present invention and its practical application, to thereby enable others skilled in the art to best utilize the present invention and its embodiments with modifications as suited to the use contemplated.

It is therefore submitted that the present invention has been shown and described in the most practical and exemplary embodiments. It should be recognized that departures may be made which fall within the scope of the invention. With respect to the description provided herein, it is submitted that the optimal features of the invention include variations in size, materials, shape, form, function and manner of operation, assembly, and use. All structures, functions, and relationships equivalent or essentially equivalent to those disclosed are intended to be encompassed by the present invention.

I claim:

1) A wearable energy collection device, comprising:
a housing having a plurality of straps, configured to attach the housing to an arm of an individual;
a plurality of energy collection systems disposed within an interior of the housing, wherein the plurality of energy collection systems includes at least one solar energy harvesting system, at least one kinetic energy harvesting system, and at least one electrostatic energy harvesting system;
an energy storage device disposed within the interior of the housing, wherein the energy storage device is operably connected to the plurality of energy collection systems and is configured to store energy collected by one or more energy collection systems of the plurality of energy collection systems.

2) The wearable energy collection device of claim 1, further comprising a light operably connected to the energy storage device.

3) The wearable energy collection device of claim 1, further comprising a clock operably connected to the energy storage device.

4) The wearable energy collection device of claim 3, wherein the clock is configured to display a time on an outer surface of the housing.

5) The wearable energy collection device of claim 1, further comprising an external port configured to enable the energy storage device to power or charge an external device operably connected to the external port.

6) The wearable energy collection device of claim 5, wherein the external port includes a universal serial bus interface.

7) The wearable energy collection device of claim 1, wherein the energy storage device is a rechargeable battery.

8) The wearable energy collection device of claim 7, wherein the rechargeable battery is a lithium ion rechargeable battery.

9) The wearable energy collection device of claim 1, wherein the at least one solar energy harvesting system includes at least one solar panel placed on an outer surface of the housing.

10) The wearable energy collection device of claim 9, wherein the housing is a rectangular cuboid with rounded edges, wherein the outer surface is an upper surface positioned above a lower surface of the housing, wherein the lower surface is configured to contact the arm of the individual.
